(19) United States
(12) Patent Application Publication
(10) Pub. No.: US 2020/0202785 A1
(43) Pub. Date: Jun. 25, 2020

(54) PIXEL DRIVING CIRCUIT, PIXEL DRIVING METHOD AND TOUCH DISPLAY DEVICE

(71) Applicant: BOE TECHNOLOGY GROUP CO., LTD., Beijing (CN)

(72) Inventors: Shengji YANG, Beijing (CN); Xue DONG, Beijing (CN); Xiaochuan CHEN, Beijing (CN); Hui WANG, Beijing (CN); Pengcheng LU, Beijing (CN)

(21) Appl. No.: 16/638,993

(22) PCT Filed: Jul. 31, 2019
(86) PCT No.: PCT/CN2019/098487

§ 371 Date: Feb. 13, 2020

(30) Foreign Application Priority Data
Aug. 2, 2018 (CN) 201810870519.3

(51) Int. Cl. G09G 3/3258; G06F 3/041; G09G 3/3291

(52) U.S. Cl. CPC G09G 3/3258; G09G 3/3291; G06F 3/0412; G06F 3/0416

(57) ABSTRACT

A pixel driving circuit, a pixel driving method and a touch display device are provided. The pixel driving circuit is applied in a touch display device and includes a driving unit, a light-emitting control unit, and a driving control unit. The light-emitting control unit controls the anode of the light-emitting element to be floating under the control of the light-emitting control line. The driving control unit controls a potential at the control terminal of the driving unit, a potential at the first terminal of the driving unit and a potential at the second terminal of the driving unit according to a data voltage on the data line under the control of the gate line.

### CROSS-REFERENCE TO RELATED APPLICATIONS

The present application is the U.S. national phase of PCT Application No. PCT/CN2019/098487 filed on Jul. 31, 2019, which claims a priority of the Chinese patent application No. 201810870519.3 filed on Aug. 2, 2018, which are incorporated herein by reference in its entirety.

### TECHNICAL FIELD

The present disclosure relates to the field of touch display technology, in particular to a pixel driving circuit, a pixel driving method and touch display device.

### BACKGROUND

Active-matrix organic light-emitting diode (AMOLED) displays are one of the hot topics in the field of flat panel displays. As compared with liquid crystal displays, AMOLED displays have advantages such as low energy consumption, a low production cost, light-emitting by itself, a wide viewing angle and a fast response speed. In the display fields such as mobile phones, Personal Digital Assistants (PDAs) and digital cameras, AMOLED displays have begun to replace traditional LCD displays.

The in-cell touch technology has the characteristics of being compatible with the display panel process, and is increasingly favored by panel manufacturers.

### SUMMARY

The present disclosure provides in some embodiments a pixel driving circuit, a pixel driving method and touch display device.

In one aspect, a pixel driving circuit is applied in a touch display device. The pixel driving circuit includes a driving unit, a light-emitting control unit, and a driving control unit. The driving unit includes a control terminal, a first terminal, and a second terminal. The light-emitting control unit is connected to a light-emitting control line, the first terminal of the driving unit, the second terminal of the driving unit, a first power voltage terminal, and an anode of a light-emitting element of the touch display device, and configured to, in a touch time period, under the control of the light-emitting control line, control to disconnect the first terminal of the driving unit and the first power voltage terminal, and control to disconnect the second terminal of the driving unit and the anode of the light-emitting element, to control the anode of the light-emitting element to be floating, and the driving control unit is connected to a gate line and a data line of the touch display device, the control terminal of the driving unit, the first terminal of the driving unit, and the second terminal of the driving unit, and configured to, in a display time period, under the control of the gate line, control a potential at the control terminal of the driving unit, a potential at the first terminal of the driving unit and a potential at the second terminal of the driving unit according to a data voltage on the data line, to control the driving unit to drive the light-emitting element to emit light.

During implementation, the pixel driving circuit further includes a voltage supply unit. The voltage supply unit is connected to a cathode voltage terminal, and is configured to provide a touch driving signal to the cathode voltage terminal during the touch time period, and provide a second power voltage to the cathode voltage terminal during the display time period. The cathode voltage terminal is connected to a cathode of light-emitting element.

During implementation, the pixel driving circuit further includes a reset unit. The reset unit is connected to a reset control terminal, an initial voltage terminal, and the control terminal of the driving unit, and configured to control to connect the initial voltage terminal and the control terminal of the driving unit in a reset phase included in the display time period under the control of the reset control terminal.

During implementation, the reset unit includes a reset transistor, a gate electrode of the reset transistor is connected to the reset control terminal, a first electrode of the reset transistor is connected to the initial voltage terminal, and a second electrode of the reset transistor is connected to the control terminal of the driving unit.

During implementation, the light-emitting control unit is configured to control to connect the first terminal of the driving unit and the first power voltage terminal and connect the second terminal of the driving unit and the anode of the light-emitting element in a light-emitting phase included in the display time period, control to disconnect the first terminal of the driving unit and the first power voltage terminal and disconnect the second terminal of the driving unit and the anode of the light-emitting element in the reset phase included in the display time period and a buffer phase included in the display time period.

During implementation, the light-emitting control unit comprises a first light-emitting control transistor and a second light-emitting control transistor, a gate electrode of the first light-emitting control transistor is connected to the light-emitting control line, and a first electrode of the first light-emitting control transistor is connected to the first power voltage terminal, a second electrode of the first light-emitting control transistor is connected to the first terminal of the driving unit, and a gate electrode of the second light-emitting control transistor is connected to the light-emitting control line, a first electrode of the second light-emitting control transistor is connected to the second terminal of the driving unit, and a second electrode of the second light-emitting control transistor is connected to the anode of the light-emitting element.

During implementation, the driving control unit includes a data writing-in module, an energy storage module, and a compensation control module. The data writing-in module is connected to the gate line, the data line, and the first end of the driving unit, and configured to, in the buffer phase included in the display time period, control to connect the data line and the first terminal of the driving unit to set the potential at the first terminal of the driving unit as a data voltage on the data line under the control of the gate line, a first terminal of the energy storage module is connected to the control terminal of the driving unit, and a second terminal of the energy storage module is connected to the first power voltage terminal, and the compensation control module is connected to the gate line, the control terminal of the driving unit and the second terminal of the driving unit, and configured to, in the buffering phase included in the display time period, control to connect the control terminal of the driving unit and the second terminal of the driving unit under the control of the gate line, to charge the energy storage module and increase a voltage at the control terminal of the driving unit until the driving unit disconnects the first terminal and the second terminal of the driving unit.

During implementation, the data writing-in module includes a data writing-in transistor, the energy storage module comprises a storage capacitor, the compensation control module comprises a compensation control transistor, a gate electrode of the data writing-in transistor is connected to the gate line, a first electrode of the data writing-in transistor is connected to the data line, and a second electrode of the data writing-in transistor is connected to the first terminal of the driving unit, a first terminal of the storage capacitor is connected to the control terminal of the driving unit, a second terminal of the storage capacitor is connected to the first power voltage terminal, and a gate electrode of the compensation control transistor is connected to the gate line, a first electrode of the compensation control transistor is connected to the control terminal of the driving unit, and a second electrode of the compensation control transistor is connected to the second terminal of the driving unit.

During implementation, the driving unit includes a driving transistor, a gate electrode of the driving transistor is the control terminal of the driving unit, a first electrode of the driving transistor is the first terminal of the driving unit, and a second electrode of the driving transistor is the second terminal of the driving unit.

In another aspect, a pixel driving method is applied to the pixel driving circuit. The pixel driving method includes: in a touch phase, providing a touch driving signal to a cathode voltage terminal, under the control of the light-emitting control line, controlling, by the light-emitting control unit, to disconnect the first terminal of the driving unit and the first power voltage terminal, and disconnect the second terminal of the driving unit and the anode of the light-emitting element, to control the anode of the light-emitting element to be floating, wherein the cathode voltage terminal is connected to a cathode of light-emitting element.

During implementation, the display time period includes a buffer phase and a light-emitting phase sequentially, the pixel driving method further includes: in the buffering phase of the display time period, controlling, by the light-emitting control unit, to disconnect the first terminal of the driving unit and the first power voltage terminal and disconnect the second terminal of the driving unit and the anode of the light-emitting element under the control of the light-emitting control line; controlling, by the driving unit, to connect the first terminal and the second terminal of the driving unit under the control of the control terminal of the driving unit; controlling, by the data writing-in module, to connect the data line and the first terminal of the driving unit under the control of the gate line, so as to set the potential of the first terminal of the driving unit to the data voltage on the data line; controlling, by the compensation control module, to connect the control terminal of the driving unit and the second terminal of the driving unit under the control of the gate line to charge the energy storage module and increase the voltage at the control terminal of the driving unit until the driving unit disconnects the first terminal and the second terminal of the driving unit; in the light-emitting phase of the display time period, controlling, by the light-emitting control unit, to connect the first terminal of the driving unit and the first power voltage terminal and connect the second terminal of the driving unit and the anode of the light-emitting element under the control of the light-emitting control line, driving, by the driving unit, the light-emitting element to emit light under the control of the control terminal of the driving unit.

During implementation, the pixel driving circuit further includes a reset unit, the display time period further includes a reset phase set before the buffer phase, the pixel driving method further includes: in the reset phase, controlling, by the reset unit, to connect the initial voltage terminal and the control terminal of the driving unit under the control of the reset control terminal.

During implementation, the pixel driving method further includes: in the touch time period, superimposing the touch driving signal on a light-emitting control line, the gate line, the first power voltage terminal, the data line, a reset control terminal and an initial voltage terminal.

In yet another aspect, a touch display device includes a display module. The display module includes a cathode layer and a light-emitting element arranged on a display substrate, and the pixel driving circuits arranged in a matrix of N rows and M columns and arranged on the display substrate, N and M are positive integers. The cathode layer includes a plurality of independent cathode strips, the light-emitting element includes an anode and a cathode, the anode of the light-emitting element is connected to a light-emitting control unit of the pixel driving circuit, and the cathode of the light-emitting element is connected to one of the plurality of cathode strips, each of the plurality of cathode strips is connected to a cathode voltage terminal, the plurality of cathode strips are multiplexed as touch driving electrodes during a touch time period.

During implementation, the cathode layer includes N rows of cathode strips. Cathodes of light-emitting elements included in pixel driving circuits in the nth row are all cathode strips in the nth row; n is a positive integer less than or equal to N. The display module further includes a packaging cover disposed on a side of the cathode layer away from the display substrate; and the touch display device further includes a plurality of columns of touch sensing electrodes disposed on a side of the packaging cover away from the cathode layer, and the touch sensing electrodes cross the cathode strips.

During implementation, the cathode layer includes M columns of cathode strips, cathodes of light-emitting elements included in pixel driving circuits in the mth column are all cathode strips in the mth column; m is a positive integer less than or equal to M; the display module further includes a packaging cover disposed on a side of the cathode layer away from the display substrate; and the touch display device further comprises a plurality of rows of touch sensing electrodes disposed on a side of the packaging cover away from the cathode layer, and the touch sensing electrodes cross the cathode strips.

During implementation, the touch display device further includes N gate lines and N rows of gate driving circuits. Pixel driving circuits in the same row are all connected to a corresponding gate line, the gate driving circuit is configured to provide a gate driving signal to the gate line during the display time period, and provide a touch driving signal to the gate line during the touch time period, the touch gate driving signal is a signal obtained by superimposing the gate driving signal and the touch driving signal.

During implementation, the gate driving circuit includes N stages of gate driving units, the gate driving unit includes a starting voltage terminal, a gate driving signal output terminal, a starting module, a first gate driving output module, a second gate driving output module, a first output node control module, and a second output node control module; the first gate driving output module is connected to a first output node, a first voltage terminal, and the gate driving signal output terminal, and is configured to control to connect or disconnect the gate driving signal output terminal and the first voltage terminal under the control of the first output node; the second gate driving output module is connected to a second output node, a first clock signal terminal, and the gate driving signal output terminal, and is configured to control to connect or disconnect the gate driving signal output terminal and the first clock signal terminal under the control of the second output node; the starting module is connected to a second clock signal terminal, the starting voltage terminal, and the second output node, and is configured to control to connect or disconnect the start voltage terminal and the second output node under the control of the second clock signal terminal; the first output node control module is connected to the second clock signal terminal, the second voltage terminal, the first output node and the second output node, and is configured to control to connect or disconnect the first output node and the second voltage terminal under the control of the second clock signal terminal, and control to connect or disconnect the first output node and the second clock signal terminal under the control of the second output node; the second output node control module is connected to the first voltage terminal, the first output node, the second output node, and the first clock signal terminal, and is configured to control to connect or disconnect the first voltage terminal and the second output node under the control of the first output node and the first clock signal terminal; a starting voltage terminal of the ath stage of gate driving unit included in the gate driving circuit is connected to a gate driving signal output terminal of the (a−1)th stage of gate driving unit included in the gate driving circuit, where a is an integer less than or equal to N and greater than 1; and the first voltage terminal is configured to provide a first voltage during the display time period, and provide the touch gate driving signal during the touch time period.

During implementation, the first gate driving output module includes a first gate driving output transistor, a gate electrode thereof connected to the first output node, a first electrode thereof connected to the first voltage terminal, and a second electrode thereof connected to the gate driving signal output terminal; and a first capacitor, a first terminal thereof connected to the first output node, and a second terminal thereof connected to the first voltage terminal; the second gate driving output module comprises a second gate driving output transistor, a gate electrode thereof connected to the second output node, a first electrode thereof connected to the gate driving signal output terminal, and a second electrode thereof connected to the first clock signal terminal; and a second capacitor, a first terminal thereof connected to the second output node, and a second terminal thereof connected to the gate driving signal output terminal; the starting module may include a starting transistor, a gate electrode thereof connected to the second clock signal terminal, a first electrode thereof connected to the start voltage terminal, and a second electrode thereof connected to the second output node; the first output node control module comprises a first output node control transistor, a gate electrode thereof connected to the second clock signal terminal, a first electrode thereof connected to the second voltage terminal, and a second electrode thereof connected to the first output node; and a second output node control transistor, a gate electrode thereof connected to the second output node, a first electrode thereof connected to the first output node, and a second electrode thereof connected to the second clock signal terminal; and the second output node control module comprises a third output node control transistor, a gate electrode thereof connected to the first output node, a first electrode thereof connected to the first voltage terminal, and a fourth output node control transistor, a gate electrode thereof connected to the first clock signal terminal, a first electrode thereof connected to a second electrode of the third output node control transistor, and a second electrode thereof connected to the second output node.

During implementation, the touch display device further includes N light-emitting control lines and N rows of light-emitting control signal generating circuits. The pixel driving circuits located in the same row are all connected to a corresponding light-emitting control line; the light-emitting control signal generating circuit is configured to provide a light-emitting control signal to the light-emitting control line during a display time period, and provide a touch light-emitting control signal to the light-emitting control line during a touch time period, and the touch light-emitting control signal is a signal obtained by superimposing the light-emitting control signal and the touch driving signal.

During implementation, the light-emitting control signal generating circuit comprises N stages of light-emitting control signal generating unit; the light-emitting control signal generating unit comprises a light-emitting start terminal, a carry signal output terminal, a light-emitting control signal output terminal, a carry signal output module, and a light-emitting control signal output module; the carry signal output module is connected to the light-emitting start terminal and the carry signal output terminal, and is configured to output a carry signal through the carry signal output terminal; the light-emitting control signal output module is connected to the carry signal output terminal, the light-emitting control signal output terminal, a first voltage terminal, a second voltage terminal, a third clock signal terminal, a fourth clock signal terminal, and a third voltage terminal, and is configured to control to connect the light-emitting control signal output terminal and the first voltage terminal or the third voltage terminal under the control of the carry signal output terminal, the third clock signal terminal, the fourth clock signal terminal, the first voltage terminal, and the second voltage terminal; a light-emitting start end of the bth stage of light-emitting control signal generation unit included in the light-emitting control signal generation circuit is connected to a carry signal output end of the (b−1) stage of light-emitting control signal generation unit included in the light-emitting control signal generation circuit; where b is an integer less than or equal to N and greater than 1. The third voltage terminal is configured to provide a touch light-emitting control signal during the touch time period, and provide a second voltage during the display time period.

During implementation, the light-emitting control signal output module includes: a first light-emitting control transistor, a gate electrode thereof connected to the carry signal output terminal, and a first electrode thereof connected to the first voltage terminal; a second light-emitting control transistor, a gate electrode thereof connected to the fourth clock signal terminal, a first electrode thereof connected to a second electrode of the first light-emitting control transistor, and a second electrode thereof connected to the second voltage terminal; a first light-emitting control signal output transistor, a gate electrode thereof connected to the carry signal output terminal, a first electrode thereof connected to the first voltage terminal, and a second electrode thereof connected to the light-emitting control signal output terminal; a second light-emitting control signal output transistor, a gate electrode thereof connected to a second electrode of the first light-emitting control transistor, a first electrode thereof connected to the light-emitting control signal output terminal, a second electrode thereof connected to the third voltage terminal; and a voltage maintaining capacitor, a first terminal thereof connected to the gate electrode of the second light-emitting control signal output transistor, and a second terminal thereof connected to the third clock signal terminal.

During implementation, the carry signal output module includes a carry start module, a first carry output module, a second carry output module, a first control node control module, and a second control node control module, the first carry output module is connected to a first control node, the first voltage terminal and the carry signal output terminal, and is configured to control to connect or disconnect the carry signal output terminal and the first voltage terminal under the control of the first control node; the second carry output module is connected to a second control node, a third clock signal terminal and the carry signal output terminal, and is configured to control to connect or disconnect the carry signal output terminal and the third clock signal terminal under the control of the second control node; the carry start module is connected to a fourth clock signal terminal, the light-emitting start terminal, and the second control node, and is configured to control to connect or disconnect a light-emitting start end and the second control node under the control of the fourth clock signal terminal; the first control node control module is connected to the fourth clock signal terminal, the second voltage terminal, the first control node and the second control node, and is configured to control to connect or disconnect the first control node and the second voltage terminal under the control of the fourth clock signal terminal, and control to connect or disconnect the first control node and the fourth clock signal end under the control of the second control node; and the second control node control module is connected to the first voltage terminal, the first control node, the second control node, and the third clock signal terminal, and is configured to control to connect or disconnect the first voltage terminal and the second control node under the control of the first control node and the third clock signal terminal.

During implementation, the first carry output module includes a first carry output transistor, a gate electrode thereof connected to the first control node, a first electrode thereof connected to the first voltage terminal, and a second electrode thereof connected to the carry signal output terminal; and a third capacitor, a first terminal thereof connected to the first control node, and a second terminal thereof connected to the first voltage terminal; the second carry output module comprises a second carry output transistor, a gate electrode thereof connected to the second control node, a first electrode thereof connected to the carry signal output terminal, and a second electrode thereof connected to the third clock signal terminal; and a fourth capacitor, a first terminal thereof connected to the second control node, and a second terminal thereof connected to the carry signal output terminal; the carry start module comprises a carry start transistor, a gate electrode thereof connected to the fourth clock signal terminal, a first electrode thereof connected to the light-emitting start terminal, and a second electrode thereof connected to the second control node; the first control node control module comprises a first control node control transistor, a gate electrode thereof connected to the fourth clock signal terminal, a first electrode thereof connected to the second voltage terminal, and a second electrode thereof connected to the first control node; and a second control node control transistor, a gate electrode thereof connected to the second control node, a first electrode thereof connected to the first control node, and a second electrode thereof connected to the fourth clock signal terminal; and the second control node control module comprises a third control node control transistor, a gate electrode thereof connected to the first control node, and a first electrode thereof connected to the first voltage terminal; and a fourth control node control transistor, a gate electrode thereof connected to the third clock signal terminal, a first electrode thereof connected to a second electrode of the third control node control transistor, and a second electrode thereof connected to the second output node.

### BRIEF DESCRIPTION OF THE DRAWINGS

FIG. 1 is a first structural diagram of a pixel driving circuit according to an embodiment of the present disclosure;

FIG. 2 is a second structural diagram of a pixel driving circuit according to an embodiment of the present disclosure;

FIG. 3 is a third structural diagram of a pixel driving circuit according to an embodiment of the present disclosure;

FIG. 4 is a circuit diagram of a pixel driving circuit according to an embodiment of the present disclosure;

FIG. 5 is an operation time sequence diagram of the pixel driving circuit shown in FIG. 4 according to an embodiment of the present disclosure;

FIG. 6 is a structural diagram of a gate driving unit included in a gate driving circuit in a touch display device according to an embodiment of the present disclosure;

FIG. 7 is a circuit diagram of the gate driving unit according to an embodiment of the present disclosure;

FIG. 8 is an operation time sequence diagram of the gate driving unit shown in FIG. 7 according to an embodiment of the present disclosure;

FIG. 9A is an equivalent circuit diagram of the gate driving unit at the initial stage S81 according to an embodiment of the present disclosure;

FIG. 9B is an equivalent circuit diagram of the gate driving unit in the output stage S82 according to an embodiment of the present disclosure;

FIG. 9C is an equivalent circuit diagram of the gate driving unit in a reset stage S83 according to an embodiment of the present disclosure;

FIG. 9D is an equivalent circuit diagram of the gate driving unit in the output cut-off maintenance stage S84 according to an embodiment of the present disclosure;

FIG. 9E is an equivalent circuit diagram of the gate driving unit in a first touch phase S85-a included in a touch time period according to an embodiment of the present disclosure;

FIG. 9F is an equivalent circuit diagram of the gate driving unit in the second touch phase S85-b included in the touch time period according to an embodiment of the present disclosure;

FIG. 10 is a structural diagram of a light-emitting control signal generation unit included in a light-emitting control generation circuit in a touch display device according to an embodiment of the present disclosure;

FIG. 11 is a circuit diagram of the light-emitting control signal generating unit according to an embodiment of the present disclosure;

FIG. 12 is an operation time sequence diagram of the light-emitting control signal generating unit shown in FIG. 11 according to an embodiment of the present disclosure;

FIG. 13A is an equivalent circuit diagram of the light-emitting control signal generating unit at the initial stage S81 according to an embodiment of the present disclosure;

FIG. 13B is an equivalent circuit diagram of the light-emitting control signal generating unit at an output stage S82 according to an embodiment of the present disclosure;

FIG. 13C is an equivalent circuit diagram of the light-emitting control signal generating unit in a reset phase S83 according to an embodiment of the present disclosure;

FIG. 13D is an equivalent circuit diagram of the light-emitting control signal generating unit in the output cut-off maintenance phase S84 according to an embodiment of the present disclosure;

FIG. 13E is an equivalent circuit diagram of the light-emitting control signal generating unit in a first touch phase S85-a included in a touch time period according to an embodiment of the present disclosure;

FIG. 13F is an equivalent circuit diagram of the light-emitting control signal generating unit in a second touch phase S85-b included in a touch time period according to an embodiment of the present disclosure;

FIG. 14 is a structural diagram of a touch display device according to an embodiment of the present disclosure;

FIG. 15 is a schematic diagram of a positional relationship between a touch sensing electrode RX and a touch driving electrode TX according to an embodiment of the present disclosure;

FIG. 16 is a schematic diagram of forming a plurality of cathode strips through a spacer post PS according to an embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure. Actually, the embodiments are provided so as to facilitate the understanding of the scope of the present disclosure.

The present disclosure provides a pixel driving circuit, a pixel driving method, and a touch display device. The pixel driving circuit, the pixel driving method and the touch display device of the present disclosure solve the problem of low touch accuracy of the touch display device in the related art.

The transistors used in all embodiments of the present disclosure may be thin film transistors or field effect transistors or other devices with the same characteristics. In the embodiment of the present disclosure, in order to distinguish the two electrodes of the transistor other than the gate electrode, one electrode is referred to as a first electrode, and the other electrode is referred to as a second electrode. In actual operation, the first electrode may be a drain electrode, and the second electrode may be a source electrode, or the first electrode may be a source electrode, and the second electrode may be a drain electrode.

The pixel driving circuit according to the embodiment of the present disclosure is applied to a touch display device. The touch display device may include a light-emitting element EL and a cathode layer, and the cathode layer includes a plurality of cathode strips. The plurality of cathode strips may be independent of each other. A cathode of the light-emitting element EL is connected to one of the plurality of cathode bars, and each of the plurality of cathode bars is connected to a cathode voltage terminal VC.

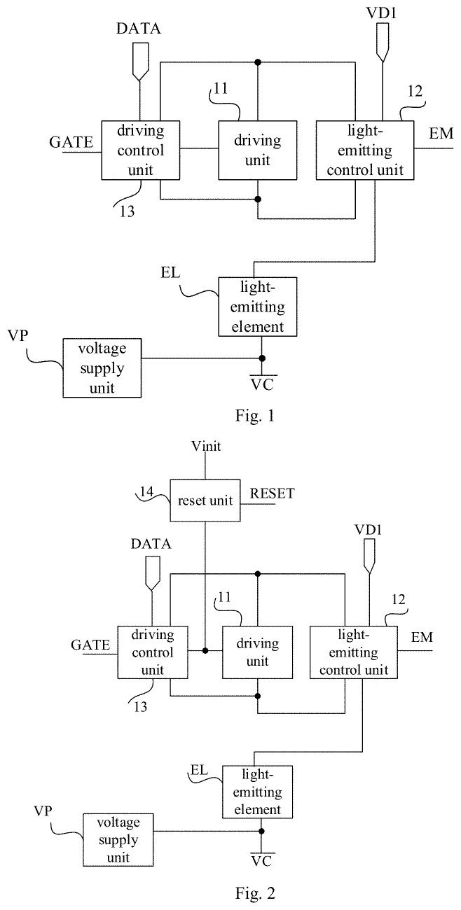

As shown in FIG. 1, the pixel driving circuit includes a driving unit 11, a light-emitting control unit 12, and a driving control unit 13. The driving unit 11 includes a control terminal, a first terminal, and a second terminal. An anode of the light-emitting element EL is connected to the light-emitting control unit 12. The light-emitting control unit 12 is connected to a light-emitting control line EM, a first terminal of the driving unit 11, a second terminal of the driving unit 11, a first power voltage terminal VD1, and the anode of the light-emitting element EL, so that in a touch time period, under the control of the light-emitting control line EM, the light-emitting control unit 12 controls to disconnect the first terminal of the driving unit 11 and the first power voltage terminal VD1, and control to disconnect a second terminal of the driving unit 11 and the anode of the light-emitting element EL, so as to control the anode of the light-emitting element EL to float.

The driving control unit 13 is connected to a gate line Gate (GATE), a data line Data (DATA), a control terminal of the driving unit 11, a first terminal of the driving unit 11, and a second terminal of the driving unit 11, so that in the display time period, under the control of the gate line Gate, the driving control unit 13 controls a potential of the control terminal of the driving unit 11, a potential of the first terminal of the driving unit 11 and a potential of the second terminal of the driving unit 11 according to the data voltage on the data line Data, so as to control the driving unit 11 to drive the light-emitting element EL to emit light.

In specific implementation, the first power supply voltage terminal VD1 may be a high power supply voltage terminal ELVDD, and the cathode voltage terminal VC may be a low power supply voltage terminal ELVSS, but is not limited thereto.

In a touch display device including a pixel driving circuit provided by an embodiment of the present disclosure, a cathode layer is formed to include a plurality of independent cathode strips, the cathode strips are multiplexed into touch driving electrode during a touch time period. In the LHB (that is, the touch time period between two display time periods), the light-emitting control signal on the light-emitting control line in the pixel driving circuit is controlled to be turned off (by a Black Frame Insertion way), so that the light-emitting element EL does not emit light, to reduce the loading of the cathode strips to the ground and improve the touch sensitivity without affecting the display effect.

In specific implementation, the cathode layer can be divided into a plurality of cathode strips by using a negative barrier way. In the embodiment of the present disclosure, the plurality of cathode strips are multiplexed into touch driving electrodes and control to turn off the light-emitting control signal in the pixel driving circuit during the touch time period to improve the touch sensitivity.

Specifically, the pixel driving circuit according to the embodiment of the present disclosure may further include a voltage supply unit VP.

The voltage supply unit VP is connected to the cathode voltage terminal, and is configured to provide a touch driving signal to the cathode voltage terminal during the touch time period, and provide a second power voltage to the cathode voltage terminal during a display time period.

In specific implementation, the second power voltage may be a low voltage so that the light-emitting element EL can emit light during a display time period. The voltage supply unit VP provides a touch driving signal to a cathode voltage terminal during a touch time period, so that the cathode strip accesses the touch driving signal, and the cathode strip is multiplexed as a touch driving electrode.

In an embodiment of the present disclosure, a time-division driving method is used to perform touch driving during a touch time period, and perform display driving during a display time period.

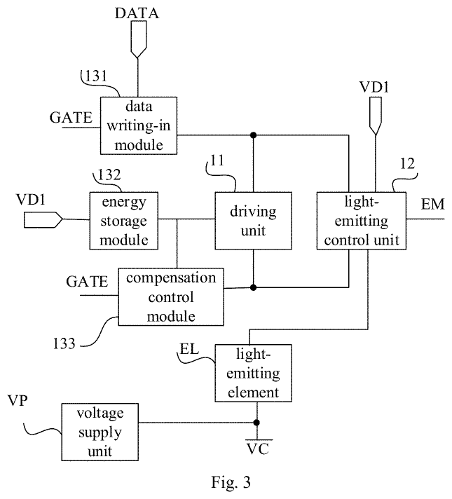

In specific implementation, based on the embodiment of the pixel driving circuit shown in FIG. 1, the pixel driving circuit as shown in FIG. 2 according to the embodiment of the present disclosure may further include a reset unit 14. The reset unit 14 is connected to a reset control terminal Reset (RESET), an initial voltage terminal Vinit, and the control terminal of the driving unit 11, and control to connect the initial voltage terminal Vinit to the control terminal of the driving unit 11 in the reset phase included in the display time period under the control of the reset control terminal Reset. The initial voltage terminal is used to input the initial voltage Vinit.

The reset unit 14 provides an initial voltage Vinit to a control terminal of the driving unit 11 in the reset phase, so as to reset a previous voltage signal of the control terminal of the driving unit 11.

Specifically, the reset unit 14 may include a reset transistor; a gate electrode of the reset transistor is connected to the reset control terminal Reset, a first electrode of the reset transistor is connected to the initial voltage terminal Vinit, and a second electrode of the reset transistor is connected to a control terminal of the driving unit.

In actual operation, the light-emitting control unit 12 is further configured to control to connect the first terminal of the driving unit and the first power voltage terminal VD1 during the light-emitting phase included in the display time period, control to connect the second terminal of the driving unit and the anode of the light-emitting element, control to disconnect the first terminal of the driving unit and the first power voltage terminal VD1 in the reset phase included in the display time period and a buffer phase included in the display time period, and control to disconnect the second terminal of the driving unit and the anode of the light-emitting element.

Specifically, the light-emitting control unit may include a first light-emitting control transistor and a second light-emitting control transistor. A gate electrode of the first light-emitting control transistor is connected to the light-emitting control line, and a first electrode of the first light-emitting control transistor is connected to the first power voltage terminal VD1, a second electrode of the first light-emitting control transistor is connected to the first terminal of the driving unit. A gate electrode of the second light-emitting control transistor is connected to the light-emitting control line EM, a first electrode of the second light-emitting control transistor is connected to the second terminal of the driving unit, and a second electrode of the second light-emitting control transistor is connected to the anode of the light-emitting element.

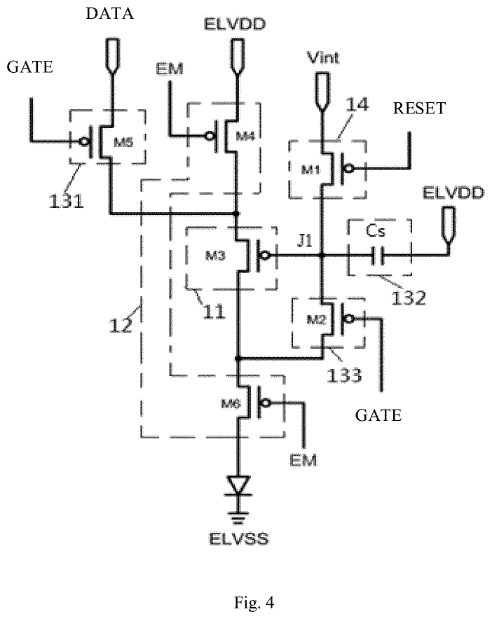

In specific implementation, based on the embodiment of the pixel driving circuit shown in FIG. 1, the driving control unit as shown in FIG. 3 may include a data writing-in module 131, an energy storage module 132, and a compensation control module 133.

The data writing-in module 131 is connected to the gate line Gate (GATE), the data line Data (DATA), and the first end of the driving unit 11, and is used to control to connect the data line Data and the first terminal of the driving unit 11 to set the potential of the first terminal of the driving unit 11 as a data voltage at the data line under the control of the gate line Gate in the buffer phase included in the display time period.

A first terminal of the energy storage module 132 is connected to a control terminal of the driving unit 11, and a second terminal of the energy storage module 132 is connected to the first power voltage terminal VD1.

The compensation control module 133 is connected to the gate line Gate, the control terminal of the driving unit 11 and the second terminal of the driving unit 11, and is used to connect the control terminal of the driving unit 11 and the second terminal of the driving unit 11 under the control of the gate line Gate in the buffering phase included in the display time period, so as to charge the energy storage module 132 and increase the voltage of the control terminal of the driving unit 11 until the driving unit 11 disconnects the first terminal and the second terminal thereof.

Specifically, the data writing-in module may include a data writing-in transistor, the energy storage module may include a storage capacitor, the compensation control module may include a compensation control transistor. A gate electrode of the data writing-in transistor is connected to the gate line Gate, a first electrode of the data writing-in transistor is connected to the data line, and a second electrode of the data writing-in transistor is connected to a first terminal of the driving unit. A first terminal of the storage capacitor is connected to a control terminal of the driving unit, a second terminal of the storage capacitor is connected to the first power voltage terminal. A gate electrode of the compensation control transistor is connected to the gate line, a first electrode of the compensation control transistor is connected to a control terminal of the driving unit, and a second electrode of the compensation control transistor is connected to a second terminal of the driving unit.

Specifically, the driving unit may include a driving transistor, the light-emitting element includes an organic light-emitting diode. A gate electrode of the driving transistor is the control terminal of the driving unit, and a first electrode of the driving transistor is the first terminal of the driving unit, and a second electrode of the driving transistor is the second terminal of the driving unit.

The pixel driving circuit described in the present disclosure will be described below through a specific example.

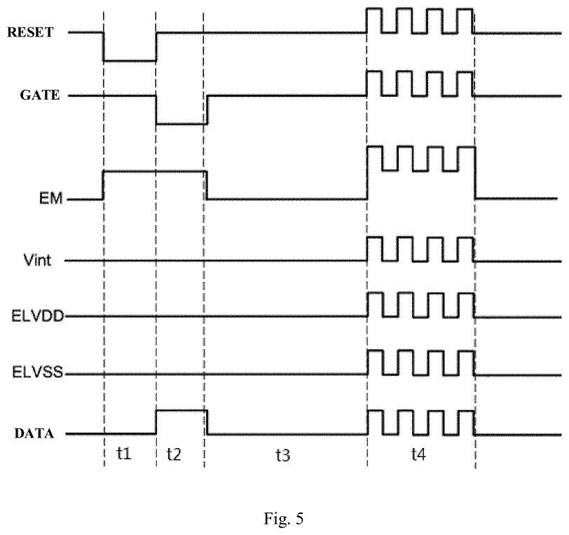

As shown in FIG. 4, the pixel driving circuit according to the present disclosure include a driving unit 11, a light-emitting control unit 12, a driving control unit, and a reset unit 14. The driving unit 11 includes a driving transistor M3, and the light-emitting control unit 12 includes a first light-emitting control transistor M4 and a second light-emitting control transistor M6, and the reset unit 14 includes a reset transistor M1.

A gate electrode of the first light-emitting control transistor M4 is connected to the light-emitting control line EM, a source electrode of the first light-emitting control transistor M4 is connected to a high power voltage terminal ELVDD, and a drain electrode of the first light-emitting control transistor M4 is connected to the source electrode of the driving transistor M3.

A gate electrode of the second light-emitting control transistor M6 is connected to the light-emitting control line EM, a source electrode of the second light-emitting control transistor M6 is connected to the drain electrode of the driving transistor M3, and a drain electrode of the second light-emitting control transistor M6 is connected to an anode of an organic light-emitting diode OLED.

A cathode of the organic light-emitting diode OLED is connected to a low power voltage terminal ELVSS.

The driving control unit includes a data writing-in module 131, an energy storage module 132, and a compensation control module 133. The data writing-in module 131 includes a data writing-in transistor M5, and the energy storage module 132 includes a storage capacitor Cs, and the compensation control module 133 includes a compensation control transistor M2.

A gate electrode of the data writing-in transistor M5 is connected to the gate line Gate, a source electrode of the data writing-in transistor M5 is connected to the data line Data, and a drain electrode of the data writing-in transistor M5 is connected to the source electrode of the transistor M3.

A first terminal of the storage capacitor Cs is connected to the gate electrode of the driving transistor M3, and a second terminal of the storage capacitor Cs is connected to the high power voltage terminal ELVDD.

A gate electrode of the compensation control transistor M2 is connected to the gate line Gate, a source electrode of the compensation control transistor M2 is connected to the gate electrode of the driving transistor M3, and a drain electrode of the compensation control transistor M2 is connected to the drain electrode of the driving transistor M3.

A gate electrode of M1 is connected to the reset control terminal Reset, a source electrode of M1 is connected to the initial voltage terminal Vinit, a drain electrode of M1 is connected to the gate electrode of the driving transistor M3; the initial voltage terminal is used to input the initial voltage Vinit.

In the specific example shown in FIG. 4, all the transistors are p-type transistors, but not limited thereto.

In the specific example shown in FIG. 4, J1 is a first node connected to the gate electrode of the driving transistor M3.

In specific implementation, in the specific example shown in FIG. 4, the first power voltage terminal is a high power voltage terminal ELVDD, the cathode voltage terminal is a low power voltage terminal ELVSS, and the high power voltage terminal ELVDD is used for inputting a high power voltage Vdd, and the initial voltage Vinit may be 0V, but is not limited thereto.

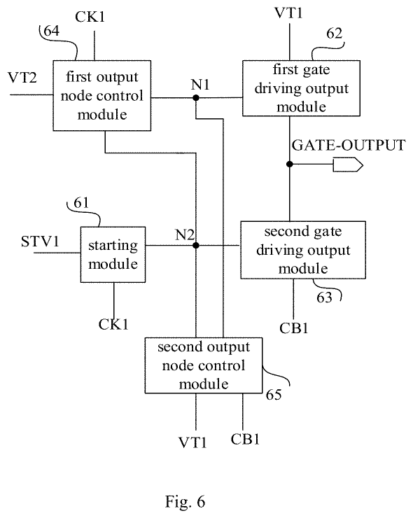

As shown in FIG. 5, a specific example of the pixel driving circuit of the present disclosure as shown in FIG. 4 is in operation as follows.

In a reset phase t1, Reset inputs a low level, Gate and EM both input a high level, M1 is turned on, the other transistors are turned off, the potential of J1 is reset to 0V, and the previous voltage signal of J1 is reset, so that M3 can be turned on at the beginning of the buffer phase t2.

In a buffer phase t2, Reset and EM both input a high level, Gate inputs a low level, M2 and M5 are both turned on, M1, M4, and M6 are turned off. Since J1 access 0V previously, M3 is turned on, the data voltage Vdata on Data starts to charge J1 through a path of M5, M3, M2 in sequence, until the potential of J1 is charged to Vdata+Vth (at this time, the gate-source voltage Vgs of M3 is Vth, and Vth is the threshold voltage of M3), M3 is disconnected. In the buffer stage t2, since the right terminal of Cs always access a high power voltage Vdd, the potential of J1 will always be maintained at Vdata+Vth after the charging is completed. In addition, the current will not pass through the OLED because M6 is turned off, the life period of the OLED is reduced indirectly.

In a light-emitting phase t3, EM inputs a low level, Reset and Gate both input a high level, M4 and M6 are both turned on, M1, M2, and M5 are all turned off, the potential of the source electrode of M3 is connected to Vdd, and the driving current holed sequentially pass through M4, M3, and M6, to make the OLED emit light. Ioled=K(Vgs−Vth)²=K[(Vdata+Vth)−Vdd−Vth]²=K(Vdata−Vdd)², where K is a current coefficient of M3, and Vgs is a gate-source voltage of M3. It can be known from the above formula that the driving current holed is no longer affected by Vth, and is only related to Vdd and Vdata. The problem of threshold voltage drift caused by thin film transistor due to process and a long-term operation is thoroughly solved to ensure the normal operation of OLED.

In a touch time period t4, a touch driving signal is written into ELVSS (that is, a touch driving signal is written into the cathode strip). The potential of the light-emitting control signal inputted by the EM is pulled up, and M4 and M6 are turned off, the cathode strip TX1 and other signal lines are driven simultaneously to ensure that all the transistors maintain an original on/off state. Since the anode of the OLED has no voltage at this time passing through it, the anode of the OLED is in a floating state. At this time, there is no need to calculate the capacitance between the cathode strip and the anode of the OLED, thereby reducing the loading of the touch driving electrode (i.e., the cathode strip). The driving efficiency can be effectively increased and the touch signal-to-noise ratio (SNR) may be increased.

It can be known from FIG. 5 that in the touch time period t4, the touch driving signal is superimposed on the reset control terminal Reset, the gate line Gate, the light-emitting control line EM, the initial voltage terminal, the high power voltage terminal ELVDD, and the data line Data, so that in the touch time period t4, all electrodes (touch driving electrodes and other opposite electrodes) are driven synchronously together to offset the influence of the capacitance to ground on the touch driving electrodes.

In FIG. 5, the reference number Vinit is the initial voltage.

In addition, since the cathode layer includes a plurality of cathode strips, when electrodes under the cathode layer are modulated, the touch sensing electrodes disposed above the cathode layer will not be affected.

In actual operation, electrodes arranged under the cathode strip (the cathode strip is reused as a touch driving electrode during the touch time period) are basically parasitic electrodes. In order to ensure the touch driving capability (reducing the loading), the most effective method is to make all the electrodes arranged under the cathode strip be driven simultaneously.

In the embodiment of the present disclosure, the parasitic electrode arranged under the cathode strip may include a reset control terminal Reset, a gate line Gate, a light-emitting control line EM, an initial voltage terminal, a high power voltage terminal ELVDD, a low power voltage terminal ELVSS, and a data line Data. The cathode strip is connected to the low power voltage terminal ELVSS.

The pixel driving method according to the embodiment of the present disclosure is applied to the above pixel driving circuit. The pixel driving method includes: in the touch time period, providing a touch driving signal to the cathode voltage terminal, under the control of the light-emitting control line, the light-emitting control unit controlling to disconnect the first terminal of the driving unit and the first power voltage terminal, and controlling to disconnect the second terminal of the driving unit and the anode of the light-emitting element, so as to control the anode of the light-emitting element to be floating.

In the pixel driving method according to the embodiment of the present disclosure, in the touch phase, a touch driving signal is provided to the cathode voltage terminal, so that the cathode strip receives the touch driving signal, so that the cathode strip is multiplexed as the touch driving electrodes, and make the light-emitting control unit turn off in the touch time period, so as not to affect the touch accuracy.

In specific implementation, the display time period includes a buffer phase and a light-emitting phase sequentially. The pixel driving method further includes the following steps.

In the buffering phase of the display time period, the light-emitting control unit controls to disconnect the first terminal of the driving unit and the first power voltage terminal and controls to disconnect the second terminal of the driving unit and the anode of the light-emitting element under the control of the light-emitting control line. The driving unit controls to connect the first terminal and the second terminal of the driving unit under the control of the control terminal of the driving unit. The data writing-in module controls to connect the data line and the first terminal of the driving unit under the control of the gate line, so as to set the potential of the first terminal of the driving unit to the data voltage on the data line. The compensation control module controls to connect the control terminal of the driving unit and the second terminal of the driving unit under the control of the gate line to charge the energy storage module and increase the voltage at the control terminal of the driving unit until the driving unit disconnects the first terminal and the second terminal thereof.

In the light-emitting phase of the display time period, the light-emitting control unit controls to connect the first terminal of the driving unit and the first power voltage terminal and controls to connect the second terminal of the driving unit and the anode of the light-emitting element under the control of the light-emitting control line. The driving unit drives the light-emitting element to emit light under the control of the control terminal of the driving unit.

In specific implementation, the pixel driving circuit may further include a reset unit. The display time period further includes a reset phase set before the buffer phase. The pixel driving method further includes: in the reset phase, the reset unit controlling to connect the initial voltage terminal and the control terminal of the driving unit under the control of the reset control terminal.

Optionally, the pixel driving method according to the embodiment of the present disclosure further includes: in the touch time period, superimposing the touch driving signal on a light-emitting control line, a gate line, a first power voltage terminal, a data line, a reset control terminal and an initial voltage terminal.

In the touch time period, a touch driving signal is superimposed on each signal line and each voltage terminal arranged under the cathode strips to improve the touch accuracy.

The touch display device according to the embodiment of the present disclosure includes a display module. The display module includes a cathode layer and a light-emitting element arranged on a display substrate, and the above-mentioned pixel driving circuits arranged in a matrix of N rows and M columns and arranged on the display substrate, where N and M are positive integers.

The cathode layer includes a plurality of independent cathode strips. The light-emitting element includes an anode and a cathode, the anode of the light-emitting element is connected to a light-emitting control unit of the pixel driving circuit, and the cathode of the light-emitting element is connected to one of the plurality of cathode strips. Each of the plurality of cathode strips is connected to a cathode voltage terminal, the cathode strips are multiplexed as touch driving electrodes during a touch time period.

The cathode layer in the touch display device according to the embodiment of the present disclosure includes a plurality of independent cathode strips, and each cathode strip is multiplexed into a touch driving electrode during a touch time period.

According to a specific embodiment, the cathode layer may specifically include N rows of cathode strips. The cathodes of the light-emitting elements included in the pixel driving circuit in the nth row are all cathode strips in the nth row; n is a positive integer less than or equal to N. The display module further includes a packaging cover disposed on a side of the cathode layer away from the display substrate. The touch display device further includes a plurality of columns of touch sensing electrodes disposed on a side of the packaging cover away from the cathode layer, and the touch sensing electrodes cross the cathode strips.

In actual operation, the touch display device further includes touch sensing electrodes disposed above the cathode layer. The touch display device according to the embodiment of the present disclosure is based on a mutual-capacitive touch driving mode and adopts a time-division driving method (that is, display driving and touch driving are performed in a time division manner).

In specific implementation, the cathode strips may be disposed laterally, and the pixel driving circuits in a same row included in the touch display device may be connected to the cathode strips in the same row.

In another specific implementation, the cathode layer may specifically include M columns of cathode strips. The cathodes of the light-emitting elements in the mth column included in the pixel driving circuit are all cathode strips in the mth column; m is a positive integer less than or equal to M. The display module further includes a packaging cover disposed on a side of the cathode layer away from the display substrate.

The touch display device further includes a plurality of rows of touch sensing electrodes disposed on a side of the packaging cover away from the cathode layer, and the touch sensing electrodes cross the cathode strips.

In a specific implementation, the cathode strips may be arranged vertically, and the pixel driving circuits in the same column included in the touch display device may be connected to the cathode strips in the same column.

The touch display device provided in the embodiments of the present disclosure may be any product or component having a touch display function, such as a mobile phone, a tablet computer, and a notebook computer.

Specifically, the touch display device according to the embodiment of the present disclosure further includes N gate lines and N rows of gate driving circuits. The pixel driving circuits in the same row are all connected to the corresponding gate line. The gate driving circuit is used to provide a gate driving signal to the gate line during the display time period, and is also used to provide a touch driving signal to the gate line during the touch time period.

The gate driving circuit is configured to provide a gate driving signal to a pixel driving circuit during the display time period, and is also configured to provide a touch gate driving signal to the gate line during a touch time period, and the touch gate driving signal is a signal obtained by superimposing the gate driving signal and the touch driving signal.

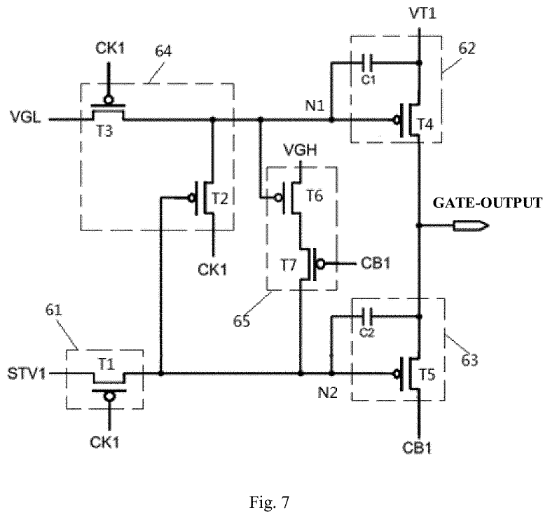

In specific implementation, the gate driving circuit may include N stages of gate driving units. As shown in FIG. 6, the gate driving unit may include a starting voltage terminal STV1, a gate driving signal output terminal Gate-Output (GATE-OUTPUT), a starting module 61, a first gate driving output module 62, a second gate driving output module 63, a first output node control module 64, and a second output node control module 65.

The first gate driving output module 62 is connected to a first output node N1, a first voltage terminal VT1, and the gate driving signal output terminal Gate-Output, and is configured to control to connect or disconnect the gate driving signal output terminal Gate-Output and the first voltage terminal VT1 under the control of the first output node N1.

The second gate driving output module 63 is connected to a second output node N2, a first clock signal terminal CB1, and the gate driving signal output terminal Gate-Output, and is configured to control to connect or disconnect the gate driving signal output terminal Gate-Output and the first clock signal terminal CB1 under the control of the second output node N2.

The starting module 61 is connected to a second clock signal terminal CK1, the starting voltage terminal STV1, and the second output node N2, and is configured to control to connect or disconnect the start voltage terminal STV1 and the second output node N2 under the control of the second clock signal terminal CK1.

The first output node control module 64 is connected to the second clock signal terminal CK1, the second voltage terminal VT2, the first output node N1 and the second output node N2, and is configured to control to connect or disconnect the first output node N1 and the second voltage terminal VT2 under the control of the second clock signal terminal CK1, and control to connect or disconnect the first output node N1 and the second clock signal terminal CK1 under the control of the second output node N2.

The second output node control module 65 is connected to the first voltage terminal VT1, the first output node N1, the second output node N2, and the first clock signal terminal CB1, and is used to control to connect or disconnect the first voltage terminal VT1 and the second output node N2 under the control of the first output node N1 and the first clock signal terminal CB1.

A starting voltage terminal of the ath stage of gate driving unit included in the gate driving circuit is connected to the gate driving signal output terminal of the (a−1)th stage of gate driving unit included in the gate driving circuit, where a is an integer less than or equal to N and greater than 1.

The first voltage terminal is configured to provide a first voltage during a display time period, and provide the touch gate driving signal during a touch time period.

In specific implementation, the first voltage may be a high voltage VGH, but is not limited thereto.

Specifically, the first gate driving output module may include a first gate driving output transistor, a gate electrode thereof connected to the first output node, a first electrode thereof connected to the first voltage terminal, and a second electrode thereof connected to the gate driving signal output terminal; and a first capacitor, a first terminal thereof connected to the first output node, and a second terminal thereof connected to the first voltage terminal.

The second gate driving output module may include a second gate driving output transistor, a gate electrode thereof connected to the second output node, a first electrode thereof connected to the gate driving signal output terminal, and a second electrode thereof connected to the first clock signal terminal; and a second capacitor, a first terminal thereof connected to the second output node, and a second terminal thereof connected to the gate driving signal output terminal.

The starting module may include a starting transistor, a gate electrode thereof connected to the second clock signal terminal, a first electrode thereof connected to the start voltage terminal, and a second electrode thereof connected to the second output node.

The first output node control module may include a first output node control transistor, a gate electrode thereof connected to the second clock signal terminal, a first electrode thereof connected to the second voltage terminal, and a second electrode thereof connected to the first output node; and a second output node control transistor, a gate electrode thereof connected to the second output node, a first electrode thereof connected to the first output node, and a second electrode thereof connected to the second clock signal terminal.

The second output node control module may include: a third output node control transistor, a gate electrode thereof connected to the first output node, a first electrode thereof connected to the first voltage terminal, and a fourth output node control transistor, a gate electrode thereof connected to the first clock signal terminal, a first electrode thereof connected to a second electrode of the third output node control transistor, and a second electrode thereof connected to the second output node.

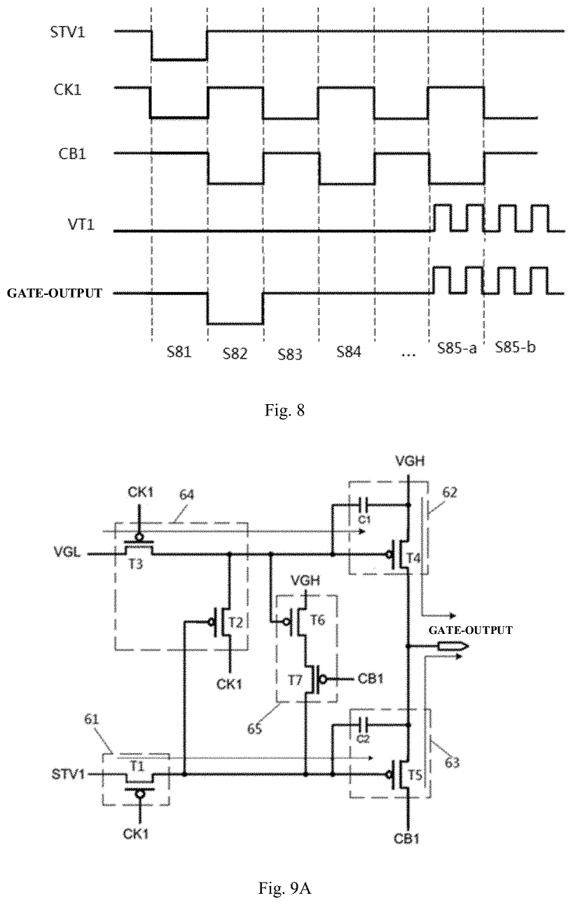

The following describes the gate driving unit through a specific example. As shown in FIG. 7, the gate driving unit includes a start voltage terminal STV1, a gate driving signal output terminal Gate-Output (GATE-OUTPUT), a starting module 61, and a first gate driving output module 62, a second gate driving output module 63, a first output node control module 64, and a second output node control module 65.

The first gate driving output module 62 includes a first gate driving output transistor T4 and a first capacitor C1. The gate electrode of T4 is connected to the first output node N1, and the source electrode of T4 is connected to the first voltage terminal VT1, and the drain electrode of T4 is connected to the Gate-Output; the first terminal of C1 is connected to the first output node N1, and the second terminal of C1 is connected to the first voltage terminal VT1.

The second gate driving output module 63 includes a second gate driving output transistor T5 and a second capacitor C2. The gate electrode of T5 is connected to the second output node N2, the drain electrode of T5 is connected to the Gate-Output, and the source electrode of T5 is connected to the first clock signal terminal CB1; the first terminal of C2 is connected to the second output node N2, and the second terminal of C2 is connected to the Gate-Output.

The starting module 61 includes a starting transistor T1, a gate electrode thereof connected to the second clock signal terminal CK1, a drain electrode thereof connected to the STV1, and a source electrode thereof connected to the second output node N2.

The first output node control module 64 includes a first output node control transistor T3 and a second output node control transistor T2. A gate electrode of T3 is connected to the second clock signal terminal CK1, and a drain electrode of T3 is connected to a low voltage VGL, a source electrode of T3 is connected to the first output node N1; the gate electrode of T2 is connected to the second output node N2, the drain electrode of T2 is connected to the first output node N1, and the source electrode of T2 It is connected to the second clock signal terminal CK1.

The second output node control module 65 includes a third output node control transistor T6 and a fourth output node control transistor T7. A gate electrode of T6 is connected to the first output node N1, and a drain electrode of T6 is connected to the first voltage terminal VT1 (VGH); the gate electrode of T7 is connected to the first clock signal terminal CB1, the drain electrode of T7 is connected to the source electrode of T6, and the source electrode of T7 is connected to the second output node N2.

In the specific example of the gate driving unit shown in FIG. 7, all the transistors are p-type transistors, but not limited thereto.

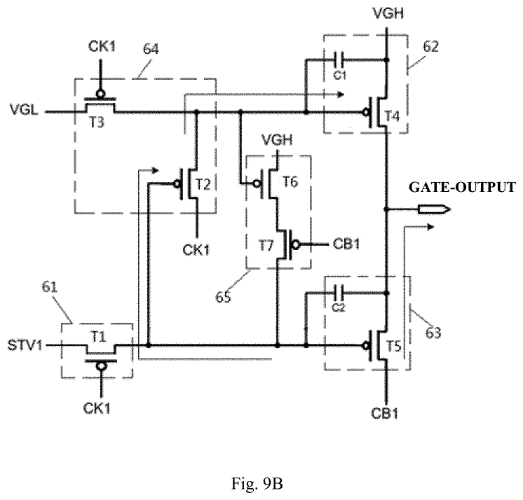

As shown in FIG. 8, the gate driving unit of the present disclosure as shown in FIG. 7 is in operation as follows.

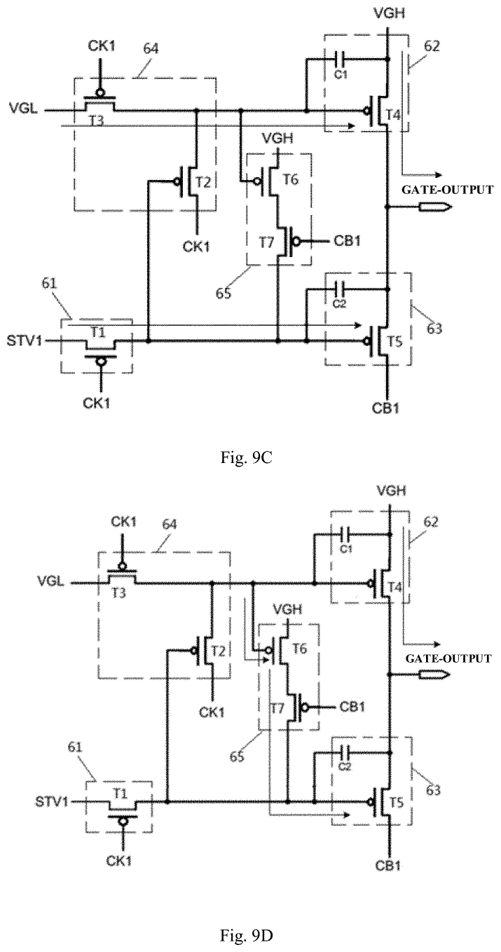

In an initial phase S81 included in the display time period, VT1 outputs a high voltage VGH, STV1 inputs a low level, and CK1 inputs a low level, CB1 inputs a high level. As shown in FIG. 9A, T1 is turned on, so that the gate electrode of T2 and the gate electrode of T5 are both connected to the low level, so that T2 and T5 are turned on, T3 is turned on, the gate electrode of T4 is connected to VGL, so that T4 is turned on, and Gate-Output outputs a high voltage VGH.

In the output phase S82 included in the display time period, VT1 outputs a high voltage VGH, STV1 inputs a high level, CK1 inputs a high level, and CB1 inputs a low level. As shown in FIG. 9B, T7 is turned on, T1 is turned off, and the potential at the gate electrode of T2 is maintained at a low level, T2 is turned on, so that the potential at the gate electrode of T4 is a high level, to control T4 to be turned off, and the potential at the gate electrode of T5 is maintained at a low level, and T5 is turned on, so that Gate-Output outputs a low level.

In the reset phase S83 included in the display time period, VT1 outputs a high voltage VGH, STV1 inputs a high level, CK1 inputs a low level, and CB1 inputs a high level. As shown in FIG. 9C, the gate electrode of T2 and the gate electrode of T5 are all connected to a high level to control T2 and T5 to be turned off, T3 is turned on, so that the gate electrode of T4 is connected to VGL, T4 is turned on, and Gate-Output outputs a high voltage VGH.

In the output cut-off maintenance phase S84 included in the display time period, VT1 outputs a high voltage VGH, STV1 inputs a high level, CK1 inputs a high level, and CB1 inputs a low level. As shown in FIG. 9D, T1 and T3 are both turned off, and the potential at the gate electrode of T2 and the potential at the gate electrode of T5 are maintained at a high level, T2 and T5 are turned off, T7 is turned on, the potential at the gate electrode of T4 and the potential at the gate electrode of T6 are maintained at a low level, and both T4 and T6 are turned on, so that the gate electrode of T5 is connected to VGH, to control T5 to be turned off, and Gate-Output outputs a high voltage VGH.

In the first touch phase S85-a included in the touch time period, VT1 outputs a touch gate driving signal, which is a signal obtained by superimposing the gate driving signal and the touch driving signal. In S85-a, the touch gate driving signal is a voltage signal obtained by superimposing a high voltage VGH and a touch scanning voltage, STV1 inputs a high level, CK1 inputs a high level, and CB1 inputs a low level, as shown in FIG. 9E, both T1 and T3 are turned off, the potential at the gate electrode of T2 and the potential at the gate electrode of T5 are maintained at a high level, T2 and T5 are turned off, T7 is turned on, the potential at the gate electrode of T4 and the potential at the gate electrode of T6 are maintained at a low level, T4 and T6 are both turned on, so that the gate electrode of T5 is connected to VGH, to control T5 to be turned off, and Gate-Output outputs the touch gate driving signal.

In the second touch phase S85-b included in the touch time period, VT1 outputs a touch gate driving signal, and the touch gate driving signal is a signal obtained by superimposing the gate driving signal and the touch driving signal. In S85-a, the touch gate driving signal is a voltage signal obtained by superimposing a high voltage VGH and a touch scan voltage. STV1 inputs a high level, CK1 inputs a low level, and CB1 inputs a high level, as shown in FIG. 9F, T1 is turned on, so that the gate electrode of T2 and the gate electrode of T5 are both connected to a high level to control both T2 and T5 to be turned off, and T3 is turned on, so that the gate electrode of T4 is connected to VGL, T4 is turned on, and Gate -Output outputs the touch gate driving signal.

In a specific implementation, the touch display device according to the embodiment of the present disclosure may further include N light-emitting control lines and N rows of light-emitting control signal generating circuits; the pixel driving circuits located in the same row are all connected to the corresponding light-emitting control line. The light-emitting control signal generating circuit is configured to provide a light-emitting control signal to the light-emitting control line during a display time period, and is also used to provide a touch light-emitting control signal to the light-emitting control line during a touch time period, and the touch light-emitting control signal is a signal obtained by superimposing the light-emitting control signal and the touch driving signal.

Specifically, the light-emitting control signal generating circuit may include N stages of light-emitting control signal generating unit. The light-emitting control signal generating unit includes a light-emitting start terminal, a carry signal output terminal, a light-emitting control signal output terminal, a carry signal output module, and a light-emitting control signal output module. The carry signal output module is connected to the light-emitting start terminal and the carry signal output terminal, and is configured to output a carry signal through the carry signal output terminal. The light-emitting control signal output module is connected to the carry signal output terminal, the light-emitting control signal output terminal, a first voltage terminal, a second voltage terminal, a third clock signal terminal, a fourth clock signal terminal, and a third voltage terminal, and is configured to control to connect the light-emitting control signal output terminal and the first voltage terminal or the third voltage terminal under the control of the carry signal output terminal, the third clock signal terminal, the fourth clock signal terminal, the first voltage terminal, and the second voltage terminal. The light-emitting start end of the bth stage of light-emitting control signal generation unit included in the light-emitting control signal generation circuit is connected to the carry signal output end of the (b−1) stage of light-emitting control signal generation unit included in the light-emitting control signal generation circuit; where b is an integer less than or equal to N and greater than 1. The third voltage terminal is configured to provide a touch light-emitting control signal during a touch time period, and provide a second voltage during a display time period.

In specific implementation, the second voltage may be a low voltage VGL, but is not limited thereto.

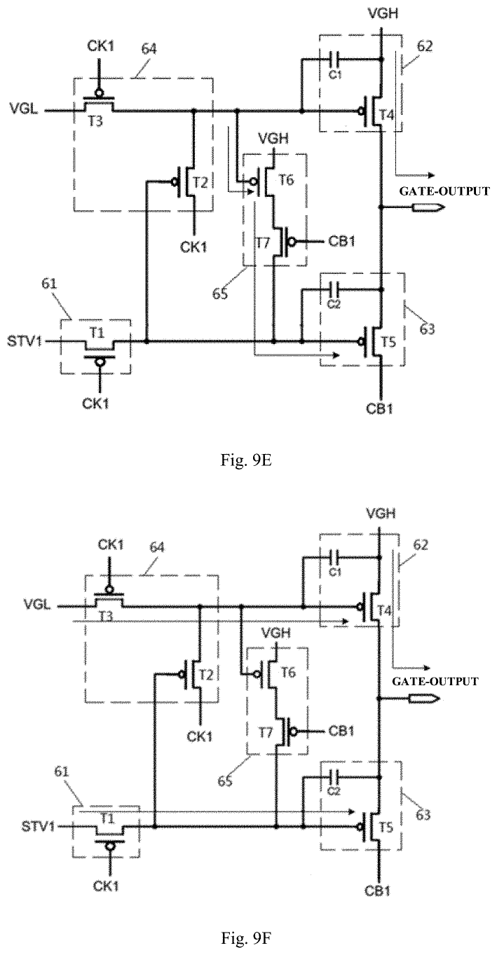

As shown in FIG. 10, the light-emitting control signal generating unit includes a light-emitting start terminal STV2, a carry signal output terminal GO, a light-emitting control signal output terminal EM-Output, a carry signal output module 101, and a light-emitting control signal output module 102.

The carry signal output module 101 is connected to the light-emitting start terminal STV2 and the carry signal output terminal GO, and is configured to output a carry signal through the carry signal output terminal GO. The light-emitting control signal output module 102 is connected to the carry signal output terminal GO, the light-emitting control signal output terminal EM-Output, a first voltage terminal VT1, a second voltage terminal VT2, a third clock signal terminal CB2, and a fourth clock signal terminal CK2 and the third voltage terminal VT3, and is used to control to connect the light-emitting control signal output terminal EM-Output and the first voltage terminal VT1 or the third voltage terminal VT3 under the control of the carry signal output terminal GO, the third clock signal terminal CB2, the fourth clock signal terminal CK2, the first voltage terminal VT1, and the second voltage terminal VT2. The third voltage terminal VT3 is configured to provide the touch light-emitting control signal during the touch time period, and provide a second voltage during the display time period.

In specific implementation, the second voltage may be a low voltage, but is not limited thereto.

Specifically, the light-emitting control signal output module may include: a first light-emitting control transistor, a gate electrode of which is connected to the carry signal output terminal, and a first electrode of which is connected to the first voltage terminal; a second light-emitting control transistor, a gate electrode of which is connected to the fourth clock signal terminal, a first electrode of which is connected to a second electrode of the first light-emitting control transistor, and a second electrode of which is connected to the second voltage terminal; a first light-emitting control signal output transistor, a gate electrode of which is connected to the carry signal output terminal, a first electrode of which is connected to the first voltage terminal, and a second electrode of which is connected to the light-emitting control signal output terminal; a second light-emitting control signal output transistor, a gate electrode of which is connected to a second electrode of the first light-emitting control transistor, a first electrode of which is connected to the light-emitting control signal output terminal, a second electrode of which is connected to the third voltage terminal; and a voltage maintaining capacitor, a first terminal of which is connected to the gate electrode of the second light-emitting control signal output transistor, and a second terminal of which is connected to the third clock signal terminal.

In actual operation, the carry signal output module may include a carry start module, a first carry output module, a second carry output module, a first control node control module, and a second control node control module.

The first carry output module is connected to a first control node, the first voltage terminal and the carry signal output terminal, and is used to control to connect or disconnect the carry signal output terminal and the first voltage terminal under the control of the first control node.

The second carry output module is connected to a second control node, a third clock signal terminal and the carry signal output terminal, and is used to control to connect or disconnect the carry signal output terminal and the third clock signal terminal under the control of the second control node.

The carry start module is connected to a fourth clock signal terminal, the light-emitting start terminal, and the second control node, and is used to control to connect or disconnect a light-emitting start end and the second control node under the control of the fourth clock signal terminal.

The first control node control module is connected to the fourth clock signal terminal, the second voltage terminal, the first control node and the second control node, and is configured to control to connect or disconnect the first control node and the second voltage terminal under the control of the fourth clock signal terminal, and control to connect or disconnect the first control node and the fourth clock signal end under the control of the second control node.

The second control node control module is connected to the first voltage terminal, the first control node, the second control node, and the third clock signal terminal, and is configured to control to connect or disconnect the first voltage terminal and the second control node under the control of the first control node and the third clock signal terminal.

Specifically, the first carry output module may include a first carry output transistor, a gate electrode thereof connected to the first control node, a first electrode thereof connected to the first voltage terminal, and a second electrode thereof connected to the carry signal output terminal; and a third capacitor, a first terminal thereof connected to the first control node, and a second terminal thereof connected to the first voltage terminal.

The second carry output module may include a second carry output transistor, a gate electrode thereof connected to the second control node, a first electrode thereof connected to the carry signal output terminal, and a second electrode thereof connected to the third clock signal terminal; and a fourth capacitor, a first terminal thereof connected to the second control node, and a second terminal thereof connected to the carry signal output terminal.

The carry start module may include a carry start transistor, a gate electrode thereof connected to the fourth clock signal terminal, a first electrode thereof connected to the light-emitting start terminal, and a second electrode thereof connected to the second control node.

The first control node control module may include a first control node control transistor, a gate electrode thereof connected to the fourth clock signal terminal, a first electrode thereof connected to the second voltage terminal, and a second electrode thereof connected to the first control node; and a second control node control transistor, a gate electrode thereof connected to the second control node, a first electrode thereof connected to the first control node, and a second electrode thereof connected to the fourth clock signal terminal.

The second control node control module may include a third control node control transistor, a gate electrode thereof connected to the first control node, and a first electrode thereof connected to the first voltage terminal; and a fourth control node control transistor, a gate electrode thereof connected to the third clock signal terminal, a first electrode thereof connected to a second electrode of the third control node control transistor, and a second electrode thereof connected to the second output node.

The following describes the light-emitting control signal generating unit through a specific example.

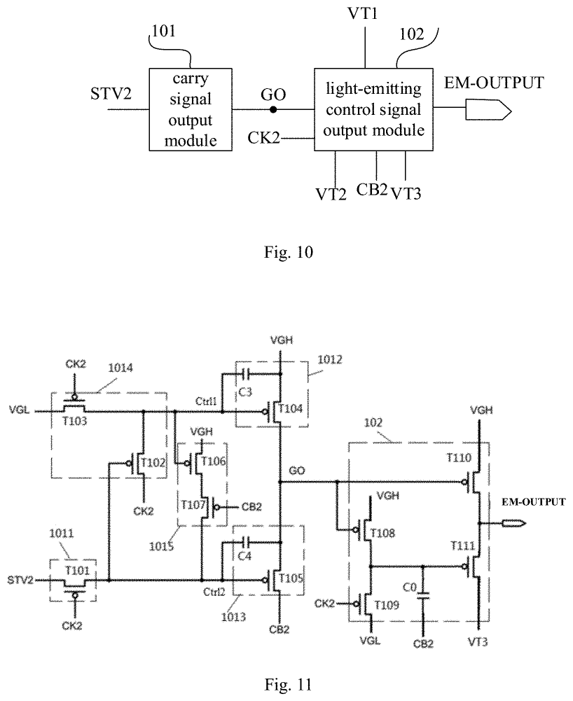

As shown in FIG. 11, the light-emitting control signal generating unit includes: a light-emitting start end STV2, a carry signal output end GO, a light-emitting control signal output end EM-Output, a carry signal output module 101, and a light-emitting control signal output Module 102.

Specifically, the light-emitting control signal output module 102 includes: a first light-emitting control transistor T108, a gate electrode thereof connected to the carry signal output terminal GO and a source electrode thereof connected to a high voltage terminal, the high voltage terminal inputting a high voltage VGH; a second light-emitting control transistor T109, a gate electrode thereof connected to the fourth clock signal terminal CK2, a source electrode thereof connected to a drain electrode of the first light-emitting control transistor T108, and a drain electrode thereof connected to a low-voltage terminal, the low-voltage terminal inputting a low voltage VGL; a first light-emitting control signal output transistor T110, a gate electrode thereof connected to the carry signal output terminal GO, a source electrode thereof connected to the high-voltage terminal, and a drain electrode thereof connected to the light-emitting control signal output terminal EM-Output; a second light-emitting control signal output transistor T111, a gate electrode thereof connected to the drain electrode of the first light-emitting control transistor T108, a source electrode thereof connected to the light-emitting control signal output terminal EM-Output, and a drain electrode thereof connected to the third voltage terminal VT3; and a voltage maintaining capacitor CO, a first terminal thereof connected to the gate electrode of the second light-emitting control signal output transistor T111, and a second terminal thereof connected to the third clock signal terminal CB2.

The carry signal output module includes a carry start module 1011, a first carry output module 1012, a second carry output module 1013, a first control node control module 1014, and a second control node control module 1015.

The first carry output module 1012 may include a first carry output transistor T104, a gate electrode thereof connected to the first control node Ctrl1, a source electrode thereof connected to the high voltage terminal, and a drain electrode thereof connected to the carry signal output terminal GO; and a third capacitor C3, the first terminal thereof connected to the first control node Ctrl1, and the second terminal thereof connected to the high voltage terminal.

The second carry output module 1013 includes a second carry output transistor T105, a gate electrode thereof connected to the second control node Ctrl2, a source electrode thereof connected to the carry signal output terminal GO, and a drain electrode thereof connected to the third clock signal terminal CB2; and a fourth capacitor C4, a first terminal thereof connected to the second control node Ctrl2, and a second terminal thereof connected to the carry signal output terminal GO.

The carry start module 1011 includes a carry start transistor T101, a gate electrode thereof connected to the fourth clock signal terminal CK2, a source electrode thereof connected to the light-emitting start terminal STV2, and a drain electrode thereof connected to the second control node Ctrl2.

The first control node control module 1014 includes: a first control node control transistor T103, a gate electrode thereof connected to the fourth clock signal terminal CK2, a source electrode thereof connected to the low voltage terminal, and a drain electrode thereof connected to the first control Node Ctrl1; a second control node transistor T102, a gate electrode thereof connected to the second control node Ctrl2, a source electrode thereof connected to the first control node Ctrl1, and a drain electrode thereof connected to the fourth clock signal terminal CK2.

The second control node control module 1015 includes a third control node control transistor T106, a gate electrode thereof connected to the first control node Ctrl1, and a source electrode thereof connected to the high voltage terminal; and a fourth control node control transistor T107, a gate electrode thereof connected to the third clock signal terminal CB2, a source electrode thereof connected to a drain electrode of the third control node control transistor T106, and a drain electrode thereof connected to the second control node Ctrl2.

The third voltage terminal VT3 is used to provide a touch light emitting control signal during the touch time period and provide a low voltage VGL during the display time period.

In the specific example of the gate driving unit shown in FIG. 11, all the transistors are p-type transistors, but not limited thereto.

In the specific example of the gate driving unit shown in FIG. 11, the first voltage terminal is a high voltage terminal inputting a high voltage VGH, and the second voltage terminal is a low voltage terminal inputting a low voltage VGL, but it is not limited thereto. In actual operation, the signal inputted by the second voltage terminal may be the same as the signal inputted by the third voltage terminal.

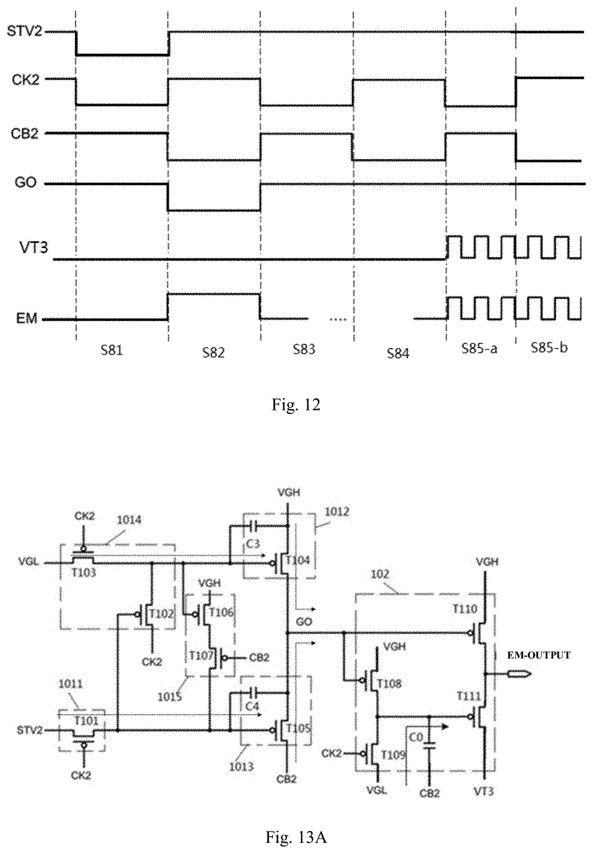

As shown in FIG. 12, the light-emitting control signal generating unit shown in FIG. 11 of the present disclosure is in operation as follows.

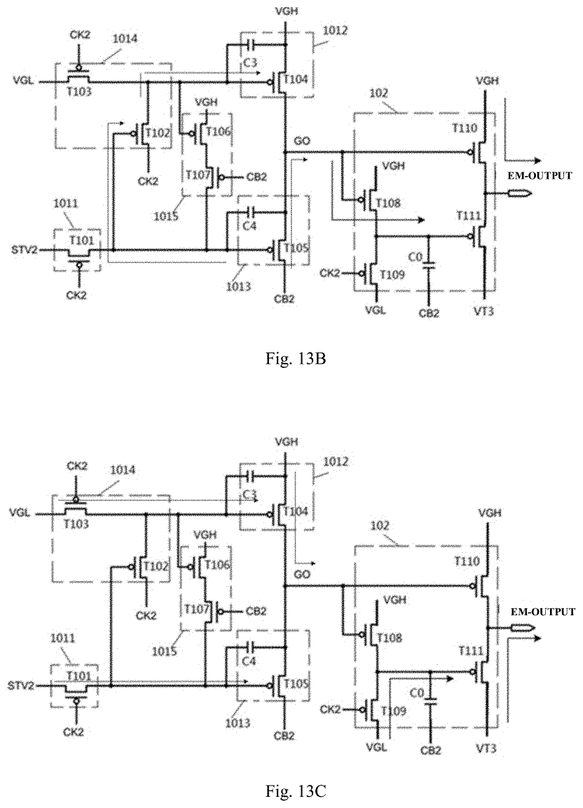

In the initial phase S81, STV2 inputs a low level, CK2 inputs a low level, CB2 inputs a high level, VT3 inputs a low voltage VGL. As shown in FIG. 13A, T101 is turned on, so that the gate electrode of T102 and the gate electrode of T105 are both connected to a low level, T102 and T105 are turned on, T103 is turned on, the gate electrode of T104 is connected to VGL, T104 is turned on, GO outputs a high voltage VGH, both T108 and T110 are turned off, and T109 is turned on, the gate electrode of T111 is connected to VGL, T111 is turned on, and EM-Output outputs a low voltage VGL.

In the output phase S82, STV2 inputs a high level, CK2 inputs a high level, CB2 inputs a low level, VT3 inputs a low voltage VGL. As shown in FIG. 13B, T107 is turned on, T101 is turned off, and the potential at the gate electrode of T102 is maintained at a low level, T102 is turned on, so that the potential at the gate electrode of T104 is at a high level, T104 is turned off, and the potential at the gate electrode of T105 is maintained at a low level, T105 is turned on, GO outputs a low level, T108 and T110 are both turned on, T109 is turned off, the gate electrode of T111 is connected to VGH, T111 is turned off, and EM-Output outputs a high voltage VGH.

In the reset phase S83, STV2 inputs a high level, CK2 inputs a low level, CB2 inputs a high level, and VT3 inputs a low voltage VGL. As shown in FIG. 13C, T101 is turned on, so that the gate electrode of T102 and the gate electrode of T105 are both connected to a high level to control T102 and T105 to be turned off and T103 to be turned on, the gate electrode of T104 is connected to VGL, T104 is turned on, GO outputs a high level, T108 and T110 are both turned off, T109 is turned on, and the gate electrode of T111 is connected to VGL, T111 is turned on, EM-Output outputs a low voltage VGL.

In the output cut-off maintenance phase S84, STV2 inputs a high level, CK2 inputs a high level, CB2 inputs a low level, VT3 inputs a low voltage VGL. As shown in FIG. 13D, T101 and T103 are both turned off, and the potential at the gate electrode of T102 and the potential at the gate electrode of T105 are maintained at a high level, T102 and T105 are turned off, T107 is turned on, the potential at the gate electrode of T104 and the potential at the gate electrode of T106 are maintained at a low level, and both T104 and T106 are turned on, the gate electrode of T105 is connected to VGH to control T105 to be turned off, and GO outputs a high voltage VGH, T108 and T110 are both turned off, T109 is turned off, the potential at the gate electrode of T111 is kept at a low level by CO, T111 is turned on, and EM-Output outputs a low voltage VGL.

In the first touch phase S85-a included in the touch time period, VT3 outputs a touch light-emitting control signal, which is a signal obtained by superimposing a light-emitting control signal and a touch driving signal. In S85-a, the touch emission control signal is a voltage signal obtained by superimposing a low voltage VGL and a touch scan voltage. STV2 inputs a high level, CK2 inputs a low level, and CB2 inputs a high level. As shown in FIG. 13E, T101 and T103 are turned on, the potential at the gate electrode of T102 and the potential at the gate electrode of T105 are maintained at a high level, T102 and T105 are turned off, T107 is turned off, the potential at the gate electrode of T104 and the potential at the gate electrode of T106 are maintained at a low level, T104 and T106 are both turned on, GO outputs a high voltage VGH, T108 and T110 are both turned off, T109 is turned on, the potential at the gate electrode of T111 is VGL, T111 is turned on, and EM-Output outputs the touch light-emitting control signal.

In the second touch phase S85-b included in the touch time period, the VT3 outputs a touch light-emitting control signal. The touch light-emitting control signal is a signal obtained by superimposing the light-emitting control signal and the touch driving signal. In S85-b, the touch light-emitting control signal is a voltage signal obtained by superimposing a low voltage VGL and a touch scan voltage, STV2 inputs a high level, CK2 inputs a high level, and CB2 inputs a low level, as shown in FIG. 13F, T101 is turned off, the gate electrode of T102 and the gate electrode of T105 are maintained at a high level, T102 and T105 are turned off, and T103 is turned off, so that the gate electrode of T104 is maintained at a low level, T104 is turned on, GO outputs a high voltage VGH, T108 and T110 are both turned off, T109 is turned off, the potential at the gate electrode of T111 is kept at a low level by CO, T111 is turned on, and EM-Output outputs the touch light-emitting control signal.

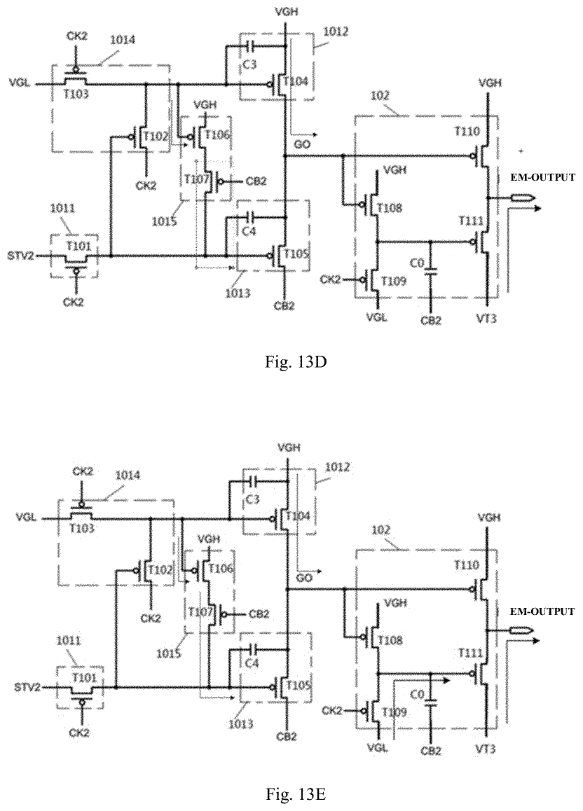

As shown in FIG. 14, the touch display device according to the embodiment of the present disclosure is an embedded mutual-capacitive Active-matrix organic light-emitting diode (AMOLED) touch module. The touch sensing electrode RX is located outside the packaging structure, and a cover glass 143 is provided above the touch sensing electrode RX. The cover glass 143 is used to protect the touch display module. A plurality rows of cathode strips included in the cathode layer 141 are multiplexed as touch driving electrodes TX. In FIG. 14, the reference numeral BP represents a display substrate, the reference numeral 142 represents a light-emitting device, the reference numeral Ano represents an anode, and the reference numeral 140 represents a packaging cover.

In specific implementation, the touch sensing electrode RX may be made of Indium Tin Oxide (ITO).

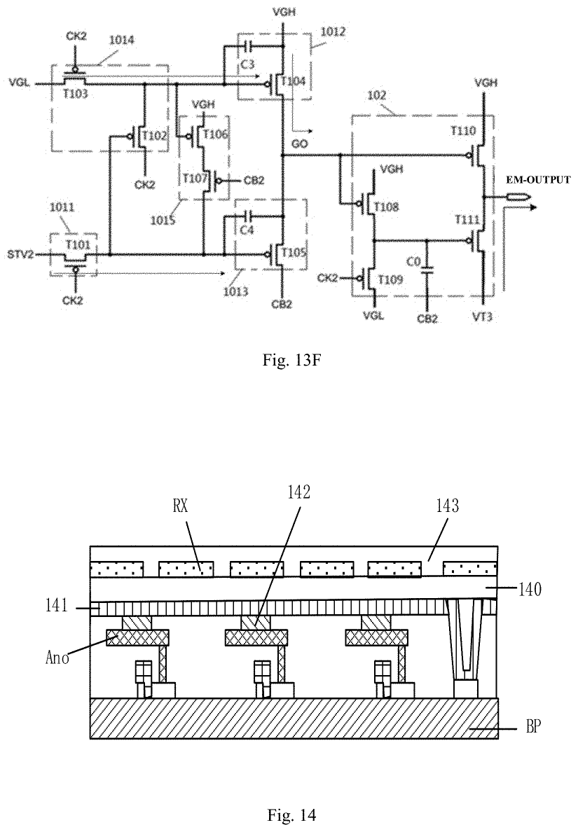

As shown in FIG. 15, the touch sensing electrodes RX are vertically arranged, and the touch driving electrodes TX (i.e., the cathode strips) are horizontally arranged.

When the touch display device according to the embodiment of the present disclosure is in operation, the original coupling electric field formed between RX and TX is changed by introducing a finger, thereby obtaining a specific touch position of the finger.

According to the built-in self-capacitive touch principle, there is strict requirements on capacitance of the touch driving electrode TX to ground, it is required that all electrodes (touch driving electrodes and other opposite electrodes) are driven simultaneously during the touch time period, so as to offset the influence of the capacitor on the touch driving electrodes. Therefore, according to the pixel driving circuit described in the embodiment of the present disclosure, when each voltage is driven together with the touch driving electrode, the value of output current of OLED may not change.

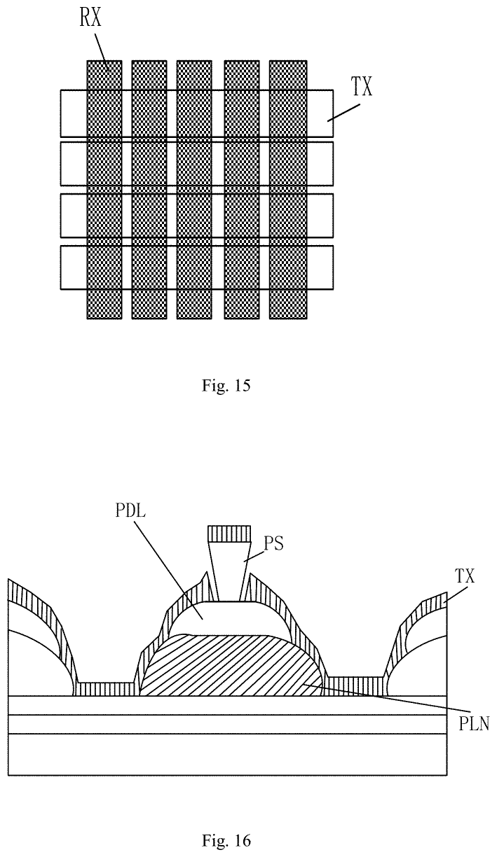

As shown in FIG. 16, in the embodiment of the present disclosure, a cathode spacer support technology and a negative photolithography process are applied to manufacture an OLED array back plate provide with a spacer support PS. Two adjacent strip-shaped cathode strips are naturally disconnected.

In FIG. 16, the reference numeral TX represents a touch driving electrode (i.e., the cathode strip), the reference numeral PDL represents a pixel defining layer, and the reference numeral PLN represents a planarization layer.

After a Thin Film Encapsulation (TFE) structure is manufactured, touch sensing electrodes need to be manufactured on the TFE structure in a low damage manner to minimize its damage to the OLED.

An embodiment of the present disclosure provides an embedded mutual-capacitance AMOLED touch device. The cathode strip is divided and reused, and the cathode is divided into cathode strips by a negative barrier way. Each cathode strip is one touch driving electrode TX. The touch driving electrode and the touch sensing electrode RX provided outside the TFE packaging are driven in a time-division manner to ensure that the opposite electrodes are synchronously modulated during touch time period. In this way, the loading of the cathode strip (that is, the touch driving electrode TX) to the ground is minimized and the touch sensitivity is improved in a maximum degree under the condition of decreasing the process difficulty.

Compared with the related art, in the pixel driving circuit, the pixel driving method, and the touch display device according to the present disclosure, the cathode layer includes a plurality of cathode strips, the cathode strips are multiplexed as touch driving electrodes during the touch time period, and in LHB (that is, the touch time period between two display time periods), the light control signal on the light control line of the pixel driving circuit is off (by black frame insertion), so that the light-emitting element EL does not emit light, so as to reduce the loading of the cathode strips to the ground, improve the touch sensitivity without affecting the display effect.

In the embodiment of the present disclosure, the touch function is embedded inside the screen, and it is possible to integrate the embedded mutual-capacitive touch technology and the AMOLED technology through driving the electrodes simultaneously. In the embodiment of the present disclosure, the cathode is divided on the premise that the process conditions can meet the requirements through the mutual capacitance design. This method ensures the process yield to the greatest extent.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A pixel driving circuit applied in a touch display device, comprising a driving unit, a light-emitting control unit, and a driving control unit, wherein
the driving unit comprises a control terminal, a first terminal, and a second terminal,
the light-emitting control unit is connected to a light-emitting control line, the first terminal of the driving unit, the second terminal of the driving unit, a first power voltage terminal, and an anode of a light-emitting element of the touch display device, and configured to, in a touch time period, under the control of the light-emitting control line, control to disconnect the first terminal of the driving unit and the first power voltage terminal, and control to disconnect the second terminal of the driving unit and the anode of the light-emitting element, to control the anode of the light-emitting element to be floating, and
the driving control unit is connected to a gate line and a data line of the touch display device, the control terminal of the driving unit, the first terminal of the driving unit, and the second terminal of the driving unit, and configured to, in a display time period, under the control of the gate line, control a potential at the control terminal of the driving unit, a potential at the first terminal of the driving unit and a potential at the second terminal of the driving unit according to a data voltage on the data line, to control, the driving unit to drive the light-emitting element to emit light

2. The pixel driving circuit according to claim 1, further comprising a voltage supply unit,
wherein the voltage supply unit is connected to a cathode voltage terminal, and is configured to provide a touch driving signal to the cathode voltage terminal during the touch time period, and provide a second power voltage to the cathode voltage terminal during the display time period, and
the cathode voltage terminal is connected to a cathode of light-emitting element

3. The pixel driving circuit according to claim 1, further comprising a reset unit,
wherein the reset unit is connected to a reset control terminal, an initial voltage terminal, and the control terminal of the driving unit, and configured to control to connect the initial voltage terminal and the control terminal of the driving unit in a reset phase included in the display time period under the control of the reset control terminal.

4. The pixel driving circuit according to claim 3, wherein the reset unit comprises a reset transistor, a gate electrode of the reset transistor is connected to the reset control terminal, a first electrode of the reset transistor is connected to the initial voltage terminal, and a second electrode of the reset transistor is connected to the control terminal of the driving unit

5. The pixel driving circuit according to claim 1, wherein the light-emitting control unit is configured to control to connect the first terminal of the driving unit and the first power voltage terminal and connect the second terminal of the driving unit and the anode of the light-emitting element in a light-emitting phase included in the display time period, control to disconnect the first terminal of the driving unit and the first power voltage terminal and disconnect the second terminal of the driving unit and the anode of the light-emitting element in the reset phase included in the display time period and a buffer phase included in the display time period

6. The pixel driving circuit according to claim 5, wherein the light-emitting control unit comprises a first light-emitting control transistor and a second light-emitting control transistor,
a gate electrode of the first light-emitting control transistor is connected to the light-emitting control line, and a first electrode of the first light-emitting control transistor is connected to the first power voltage terminal, a second electrode of the first light-emitting control transistor is connected to the first terminal of the driving unit, and
a gate electrode of the second light-emitting control transistor is connected to the light-emitting control line, a first electrode of the second light-emitting control transistor is connected to the second terminal of the driving unit, and a second electrode of the second light-emitting control transistor is connected to the anode of the light-emitting element

7. The pixel driving circuit according to claim 1, wherein the driving control unit comprises a data writing-in module, an energy storage module, and a compensation control module,
the data writing-in module is connected to the gate line, the data line, and the first end of the driving unit, and configured to, in the buffer phase included in the display time period, control to connect the data line and the first terminal of the driving unit to set the potential at the first terminal of the driving unit as a data voltage on the data line under the control of the gate line,
a first terminal of the energy storage module is connected to the control terminal of the driving unit, and a second terminal of the energy storage module is connected to the first power voltage terminal, and
the compensation control module is connected to the gate line, the control terminal of the driving unit and the second terminal of the driving unit, and configured to, in the buffering phase included in the display time period, control to connect the control terminal of the driving unit and the second terminal of the driving unit under the control of the gate line, to charge the energy storage module and increase a voltage at the control terminal of the driving unit until the driving unit disconnects the first terminal and the second terminal of the driving unit

8. The pixel driving circuit according to claim 7, wherein the data writing-in module comprises a data writing-in transistor, the energy storage module comprises a storage capacitor, the compensation control module comprises a compensation control transistor,
a gate electrode of the data writing-in transistor is connected to the gate line, a first electrode of the data writing-in transistor is connected to the data line, and a second electrode of the data writing-in transistor is connected to the first terminal of the driving unit,
a first terminal of the storage capacitor is connected to the control terminal of the driving unit, a second terminal of the storage capacitor is connected to the first power voltage terminal, and
a gate electrode of the compensation control transistor is connected to the gate line, a first electrode of the compensation control transistor is connected to the control terminal of the driving unit, and a second electrode of the compensation control transistor is connected to the second terminal of the driving unit

9. The pixel driving circuit according to claim 1, wherein the driving unit comprises a driving transistor,
a gate electrode of the driving transistor is the control terminal of the driving unit, a first electrode of the driving transistor is the first terminal of the driving unit, and a second electrode of the driving transistor is the second terminal of the driving unit

10. A pixel driving method, applied to the pixel driving circuit according to claim 1, wherein the pixel driving method comprises:
in a touch phase, providing a touch driving signal to a cathode voltage terminal, under the control of the light-emitting control line, controlling, by the light-emitting control unit, to disconnect the first terminal of the driving unit and the first power voltage terminal, and disconnect the second terminal of the driving unit and the anode of the light-emitting element, to control the anode of the light-emitting element to be floating,
wherein the cathode voltage terminal is connected to a cathode of light-emitting element

11. The pixel driving method according to claim 10, wherein the display time period comprises a buffer phase and a light-emitting phase sequentially, the pixel driving method further comprises:
in the buffering phase of the display time period, controlling, by the light-emitting control unit, to disconnect the first terminal of the driving unit and the first power voltage terminal and disconnect the second terminal of the driving unit and the anode of the light-emitting element under the control of the light-emitting control line; controlling, by the driving unit, to connect the first terminal and the second terminal of the driving unit under the control of the control terminal of the driving unit; controlling, by the data writing-in module, to connect the data line and the first terminal of the driving unit under the control of the gate line, so as to set the potential of the first terminal of the driving unit to the data voltage on the data line; controlling, by the compensation control module, to connect the control terminal of the driving unit and the second terminal of the driving unit under the control of the gate line to charge the energy storage module and increase the voltage at the control terminal of the driving unit until the driving unit disconnects the first terminal and the second terminal of the driving unit; and
in the light-emitting phase of the display time period, controlling, by the light-emitting control unit, to connect the first terminal of the driving unit and the first power voltage terminal and connect the second terminal of the driving unit and the anode of the light-emitting element under the control of the light-emitting control line, driving, by the driving unit, the light-emitting element to emit light under the control of the control terminal of the driving unit

12. The pixel driving method according to claim 10, wherein the pixel driving circuit further comprises a reset unit, the display time period further comprises a reset phase set before the buffer phase, the pixel driving method further comprises:
in the reset phase, controlling, by the reset unit, to connect the initial voltage terminal and the control terminal of the driving unit under the control of the reset control terminal

13. The pixel driving method according to claim 12, further comprising:
in the touch time period, superimposing the touch driving signal on a light-emitting control line, the gate line, the first power voltage terminal, the data line, a reset control terminal and an initial voltage terminal

14. A touch display device, comprising a display module, wherein
the display module comprises a cathode layer and a light-emitting element arranged on a display substrate, and the pixel driving circuits according to claim 1 arranged in a matrix of N rows and M columns and arranged on the display substrate, N and M are positive integers, and
the cathode layer comprises a plurality of independent cathode strips, the light-emitting element comprises an anode and a cathode, the anode of the light-emitting element is connected to a light-emitting control unit of the pixel driving circuit, and the cathode of the light-emitting element is connected to one of the plurality of cathode strips, each of the plurality of cathode strips is connected to a cathode voltage terminal, the plurality of cathode strips are multiplexed as touch driving electrodes during a touch time period

15. The touch display device according to claim 14, wherein,
the cathode layer comprises N rows of cathode strips,
cathodes of light-emitting elements included in pixel driving circuits in the nth row are all cathode strips in the nth row; n is a positive integer less than or equal to N;
the display module further comprises a packaging cover disposed on a side of the cathode layer away from the display substrate; and
the touch display device further comprises a plurality of columns of touch sensing electrodes disposed on a side of the packaging cover away from the cathode layer, and the touch sensing electrodes cross the cathode strips

16. The touch display device according to claim 14, wherein
the cathode layer comprises M columns of cathode strips
cathodes of light-emitting elements included in pixel driving circuits in the mth column are all cathode strips in the mth column; m is a positive integer less than or equal to M;
the display module further comprises a packaging cover disposed on a side of the cathode layer away from the display substrate; and
the touch display device further comprises a plurality of rows of touch sensing electrodes disposed on a side of the packaging cover away from the cathode layer, and the touch sensing electrodes cross the cathode strips

17. The touch display device according to claim 14, further comprising N gate lines and N rows of gate driving circuits,
wherein pixel driving circuits in the same row are all connected to a corresponding gate line,
the gate driving circuit is configured to provide a gate driving signal to the gate line during the display time period, and provide a touch driving signal to the gate line during the touch time period, the touch gate driving signal is a signal obtained by superimposing the gate driving signal and the touch driving signal

18. The touch display device according to claim 17, wherein the gate driving circuit comprises N stages of gate driving units,
the gate driving unit comprises a starting voltage terminal, a gate driving signal output terminal, a starting module, a first gate driving output module, a second gate driving output module, a first output node control module, and a second output node control module;
the first gate driving output module is connected to a first output node, a first voltage terminal, and the gate driving signal output terminal, and is configured to control to connect or disconnect the gate driving signal output terminal and the first voltage terminal under the control of the first output node;
the second gate driving output module is connected to a second output node, a first clock signal terminal, and the gate driving signal output terminal, and is configured to control to connect or disconnect the gate driving signal output terminal and the first clock signal terminal under the control of the second output node;
the starting module is connected to a second clock signal terminal, the starting voltage terminal, and the second output node, and is configured to control to connect or disconnect the start voltage terminal and the second output node under the control of the second clock signal terminal;
the first output node control module is connected to the second clock signal terminal, the second voltage terminal, the first output node and the second output node, and is configured to control to connect or disconnect the first output node and the second voltage terminal under the control of the second clock signal terminal, and control to connect or disconnect the first output node and the second clock signal terminal under the control of the second output node;
the second output node control module is connected to the first voltage terminal, the first output node, the second output node, and the first clock signal terminal, and is configured to control to connect or disconnect the first voltage terminal and the second output node under the control of the first output node and the first clock signal terminal;
a starting voltage terminal of the ath stage of gate driving unit included in the gate driving circuit is connected to a gate driving signal output terminal of the (a−1)th stage of gate driving unit included in the gate driving circuit, where a is an integer less than or equal to N and greater than 1; and
the first voltage terminal is configured to provide a first voltage during the display time period, and provide the touch gate driving signal during the touch time period

19. The touch display device according to claim 18, wherein
the first gate driving output module comprises a first gate driving output transistor, a gate electrode thereof connected to the first output node, a first electrode thereof connected to the first voltage terminal, and a second electrode thereof connected to the gate driving signal output terminal; and a first capacitor, a first terminal thereof connected to the first output node, and a second terminal thereof connected to the first voltage terminal;
the second gate driving output module comprises a second gate driving output transistor, a gate electrode thereof connected to the second output node, a first electrode thereof connected to the gate driving signal output terminal, and a second electrode thereof connected to the first clock signal terminal; and a second capacitor, a first terminal thereof connected to the second output node, and a second terminal thereof connected to the gate driving signal output terminal;
the starting module may include a starting transistor, a gate electrode thereof connected to the second clock signal terminal, a first electrode thereof connected to the start voltage terminal, and a second electrode thereof connected to the second output node;
the first output node control module comprises a first output node control transistor, a gate electrode thereof connected to the second clock signal terminal, a first electrode thereof connected to the second voltage terminal, and a second electrode thereof connected to the first output node; and a second output node control transistor, a gate electrode thereof connected to the second output node, a first electrode thereof connected to the first output node, and a second electrode thereof connected to the second clock signal terminal; and
the second output node control module comprises a third output node control transistor, a gate electrode thereof connected to the first output node, a first electrode thereof connected to the first voltage terminal, and a fourth output node control transistor, a gate electrode thereof connected to the first clock signal terminal, a first electrode thereof connected to a second electrode of the third output node control transistor, and a second electrode thereof connected to the second output node

20. The touch display device according to claim 14, further comprising N light-emitting control lines and N rows of light-emitting control signal generating circuits, wherein
the pixel driving circuits located in the same row are all connected to a corresponding light-emitting control line;
the light-emitting control signal generating circuit is configured to provide a light-emitting control signal to the light-emitting control line during a display time period, and provide a touch light-emitting control signal to the light-emitting control line during a touch time period, and the touch light-emitting control signal is a signal obtained by superimposing the light-emitting control signal and the touch driving signal

21.-24. (canceled)
